(19) United States
(12) Patent Application Publication
(10) Pub. No.: US 2018/0178299 A1
(43) Pub. Date: Jun. 28, 2018

(54) Cutting-To-Length System, Processing Device, Distance Gauge

(71) Applicant: Robert Bosch GmbH, Stuttgart (DE)

(72) Inventor: Rudolf FUCHS, Neuhausen (DE)

(21) Appl. No.: 15/739,607

(22) PCT Filed: May 31, 2016
(86) PCT No.: PCT/EP2016/062251

§ 371 Date: Dec. 22, 2017

(30) Foreign Application Priority Data
Jun. 24, 2015 (DE) 10 2015 211 692.1

(51) Int. Cl. B23D 59/00; B27B 27/02; B27B 27/10

(52) U.S. Cl. CPC B23D 59/001; B27B 27/10; B27B 27/02

(57) ABSTRACT

A cutting-to-length system for cutting workpieces to a desired length includes a processing device and a distance gauge. The processing device has a separating tool and a longitudinal stop. The longitudinal sop is displaceably mounted to adjust a desired length between the longitudinal stop and the separating tool. The processing device and the distance gauge have a communication module for wireless or hard-wired transfer of data. A cutting-to-length system further includes an actuator. The actuator is assigned to the longitudinal stop and configured to displace the longitudinal stop. The actuator is operable to adjust the desired length as a function of at least one distance recorded by the distance gauge.

The invention relates to a cutting-to-length system for cutting workpieces to a desired length, with a processing device which has a separating tool and a longitudinal stop, said longitudinal stop being displaceably mounted for the purpose of adjusting the desired length between the longitudinal stop and the separating tool, and with a distance gauge for ascertaining the desired length.

### STATE OF THE ART

Cutting-to-length systems of the aforementioned type are already known from the prior art. If, for instance, a craftsman wishes to install a baseboard appropriately, he/she ordinarily has to cut a prefabricated strip of baseboard to length at least once—that is to say, adapt it in length—so that the cut-to-length piece of baseboard fits exactly into a remaining baseboard region. Ordinarily, the craftsman will ascertain the desired length of the portion of baseboard by measuring the length of the vacant baseboard region. For this purpose he/she generally uses a ruler or a measuring tape by way of distance gauge. As soon as he/she has recorded the desired length, he/she will, for instance, mark this down on the prefabricated baseboard and—by means of the separating tool of the processing device, which takes the form of, for instance, a miter saw, circular saw, compass saw or band saw—cut it to the dimension marked down. Alternatively, the user adjusts a longitudinal stop of the processing device in such a manner that the desired dimension—or, to be more exact, the desired length—has been adjusted between the longitudinal stop and the separating tool. By reason of manufacturing tolerances, arithmetical errors or a careless actuation of the longitudinal stop, misadjustments may easily occur.

### DISCLOSURE OF THE INVENTION

The cutting-to-length system according to the invention with the features of claim 1 has the advantage that the method described above for cutting a workpiece to a desired dimension is distinctly simplified for the user or craftsman. In addition, sources of error, such as inaccurate marking-off or calculation of a desired length, are reliably avoided. Moreover, the entire process is significantly accelerated by the invention, so that the work can be finished off more quickly. The cutting-to-length system according to the invention with the features of claim 1 is distinguished in that the processing device and the distance gauge each have a communication module for wireless or hard-wired communication with one another, and in that an actuator is assigned to the longitudinal stop for its displacement, said actuator adjusting the desired length as a function of at least one distance recorded by the distance gauge. In accordance with the invention, provision is accordingly made such that the longitudinal stop is shifted automatically to a position in which the desired length ascertained beforehand with the aid of the gauge has been adjusted between the longitudinal stop and the separating tool of the processing device. The user then only has to supply the workpiece to the processing device and, in particular, to push it past the separating tool as far as the longitudinal stop, and initiate the separating process. As a result, the workpiece, for instance the strip of baseboard, can be cut to the desired dimension—or, to be more exact, to the desired length—in a short time. The communication modules preferably take the form of radio modules, for instance Bluetooth, WLAN modules, Zigbee, ISM radio or near-field communication module and such like, in order to guarantee a simple wireless communication between the processing device and the distance gauge. Alternatively, the invention provides that the communication modules are cable-bound communication modules which are connected to one another for exchange of information by one or more lines. The actuator preferentially takes the form of an electromotive or electromagnetic actuator for shifting the longitudinal stop by means of a displacing device. For instance, the actuator can drive a spindle on which the longitudinal stop is mounted so as to be longitudinally displaceable in the manner of a spindle nut. The invention may also provide that the longitudinal stop is arranged on a toothed rack which can be displaced longitudinally with a toothed wheel which is driven or capable of being driven by the electric motor or the actuator. The invention may also provide that the longitudinal stop is held by a scissors mechanism or such like on a housing of the processing device, said scissors mechanism being operated by the actuator for the purpose of shifting the longitudinal stop. According to a further embodiment of the invention, provision is made such that the longitudinal stop is arranged at one end of a telescopic arm which can be retracted or extended by the actuator, the other end of which is expediently assigned to the processing device or to the housing of the processing device. The actuator is preferentially triggered by a control device which ascertains the desired length by means of the data of the distance gauge that have been recorded by the communication module of the processing device.

According to a preferred further development of the invention, provision is made such that the distance gauge is designed to measure the at least one distance in contactless manner. As a result, a precise and simple determination of the desired length is undertaken. In particular, as a result the desired length can also be recorded at points at which, by reason of the boundary conditions, the user can no longer correctly read off or ascertain the measured length beforehand with a mechanical distance gauge such as, for instance, a ruler or such like.

The distance gauge preferably takes the form of a laser gauge. Laser gauges for ascertaining a distance are known in principle from the prior art. In the present case, by virtue of the design as a laser gauge, a particularly exact and precise recording of the desired length results which, by virtue of the automatic transmission of the recorded distance to the processing device and by virtue of the automatic shifting of the longitudinal stop, leads to an extremely precise cutting to length of the workpiece to be processed. In a particularly preferred manner, the invention provides that the distance gauge has a mechanical, touch-sensitive or virtual switch which the user can actuate in order to label the currently recorded distance as the desired length. The distance gauge is designed in such a manner that when the switch has been actuated the currently recorded length marked as the desired length is transmitted automatically, in particular by radio, to the processing device, where the actuator automatically shifts the longitudinal stop in such a manner that the desired length is present between the longitudinal stop and the separating tool. Optionally, the distance gauge has, in addition, means for influencing the desired length, in particular for specifying a set deviation from the recorded distance, if, for instance, a gap dimension or such like is also to be taken into account as a function of the currently recorded length.

According to a preferred further development of the invention, provision is made such that the cutting-to-length system has a central unit which for the purpose of communicating with the processing device and with the distance gauge has a further communication module, in particular a radio module. Whereas in the case of the embodiment described previously the data acquired by the distance gauge with respect to the distance or desired length, optionally taking account of the gap dimension (set deviation) to be taken into account, are transferred directly to the processing device, in the case of the embodiment now being described the invention provides that the data are firstly relayed to the central unit and then from the central unit to the processing device. For instance, the data can be influenced and instantiated by means of the central unit. Accordingly, the invention provides, in particular, that the influencing of the desired length takes place not by means of the distance gauge but by means of the central unit. The central unit is preferentially a mobile telephone (smartphone), a mobile computer or a central server of the manufacturer of the system.

According to a further embodiment of the invention, provision is preferably made such that the distance gauge, the processing device or the central unit have an input device for manual entering of the desired length and/or of a set deviation from a distance recorded by the distance gauge. As a result, the user is able to enter the set deviation in straightforward manner, so that it is taken into account in the adjustment of the desired length. In this connection, the user can perform this input himself/herself on the processing device, on the central unit or on the distance gauge, depending upon where the input device has been formed or arranged. If the input device has been arranged on the processing device itself, it is furthermore possible for the user to specify the desired length directly, manually, so that a recording of a desired length by means of the distance gauge can also be dispensed with, as required. In particular, the input device exhibits the aforementioned switch.

In a particularly preferred manner, the invention provides that the input device has a touch-sensitive screen or a keypad for specifying the desired length or for specifying the set deviation from the recorded distance, such as, for instance, a gap dimension. The stated means allow the user to enter the desired length or the set deviation in straightforward manner.

Moreover, the invention preferably provides that the input device has a communication module for reception of the desired length. As a result, a manual input of the desired length and/or of a deviation from the recorded distance can be dispensed with. Rather, in this case the invention provides that the desired length and/or the set deviation is/are sent to the input device from another device, in particular from the distance gauge, so that an automatic shifting of the longitudinal stop by the actuator takes place or can take place.

According to a preferred further development of the invention, provision is made such that the separating tool is mounted so as to be capable of swiveling, for instance on a housing of the processing device. By swiveling of the separating tool, a cutting angle at which the workpiece is to be cut to length by the separating tool can be adjusted in a straightforward manner.

In a particularly preferred manner, the invention provides that the distance gauge is designed to record a cutting angle, and that a further actuator is assigned to the separating tool, said further actuator swiveling the separating tool as a function of the recorded cutting angle. By this means, it is ensured that not only the desired length but also the cutting angle are adjusted automatically, or can be adjusted automatically, by the processing device. By this means, a still more precise processing of the workpiece is reliably guaranteed. In this case the distance gauge is designed, in particular, to record at least two distances simultaneously or in succession and, in particular, to determine the cutting angle as a function of a difference between the distances. For instance, the invention may provide that the distance gauge has two laser gauges which are arranged side by side in order to ascertain the two distances simultaneously. Alternatively, the two distances can also be recorded in succession with one laser gauge.

The invention will be elucidated in more detail in the following with reference to an exemplary embodiment. Shown are:

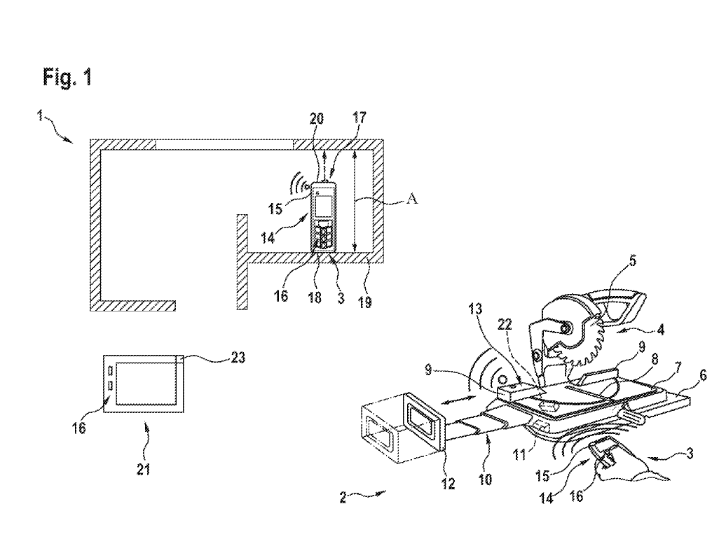

FIG. 1 a cutting-to-length system in a schematic representation and

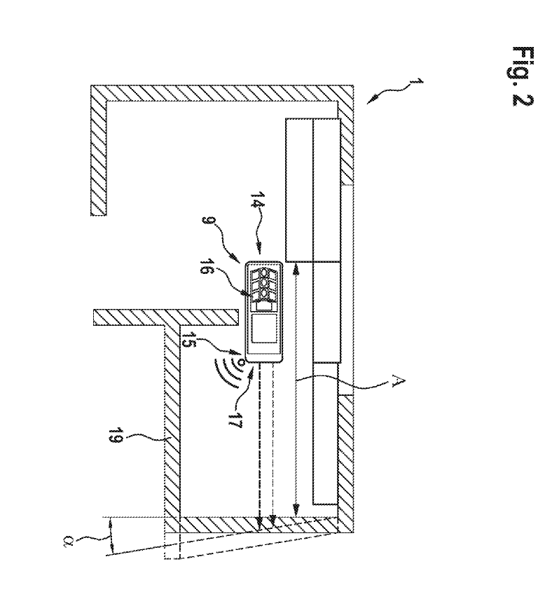

FIG. 2 the cutting-to-length system with an expanded functional scope.

FIG. 1 shows, in a simplified representation, a cutting-to-length system 1 which includes a processing device 2 and a mobile distance gauge 3.

The processing device 2 takes the form of a semi-stationary circular saw which has a rotatable circular-saw blade 5 by way of separating tool 4. The separating tool 4 is assigned to a workpiece support 7 formed on a housing 6 and can be supplied to the workpiece support 7 by being displaced or swiveled. The workpiece support 7 has a slot-shaped recess 8 into which the circular-saw blade 5 can be lowered in operation in order to sever completely a workpiece resting on the workpiece support 7. Arranged, moreover, on the workpiece support 7 are lateral stops 9 oriented perpendicularly in relation to the slot-shaped recess 8, against which the workpiece to be processed can be placed in order to orient it with respect to the circular-saw blade 5.

A circular-segment-shaped portion of the workpiece support 7 with the recess 8 and also the separating tool 4 are, in addition, mounted on the housing 6 so as to be capable of swiveling about a vertical axis, in order to be able to sever the workpiece to be machined at different angles. The lateral stops 9 are held on the fixed portion of the workpiece support 7 and preferably project into the region of the circular segment which is capable of swiveling, in order to guarantee a secure abutment of the workpiece.

Arranged, moreover, on the housing 6 is a telescopic arm 10 which can be retracted and extended by an actuator 11 which here is indicated only by dashed lines. The telescopic arm extends in a direction parallel to the longitudinal extent of the lateral stops 9. At its end facing away from the housing 6 the telescopic arm 10 has a longitudinal stop 12 which is situated at the level of the lateral stops 9 and consequently likewise projects beyond the workpiece support. A workpiece to be processed can consequently be placed onto the tool support 7 and pushed against the lateral stops 9, on the one hand, and against the longitudinal stop 12, on the other hand, in order to orient the workpiece with respect to the separating tool 4.

The processing device 2 has, moreover, a communication module 13 for wireless communication. The communication module 13 is, to this extent, a radio module which, in particular, takes the form of a Bluetooth module or WLAN module, in order, in particular, to receive adjustment data for operating the actuator 11 and, optionally, for automatic swiveling of the separating tool 4. A further actuator 22 for automatic swiveling of the separating tool 4 is assigned to the separating tool 4. The actuators 11 and 22 may take the form of electromotive and/or electromagnetic actuators.

The cutting-to-length system 1 has, moreover, an input device 14 which takes the form of a mobile appliance with a communication module 15 for wireless communication with the communication module 13. The input device 14 has a simplified keypad 16 for entering commands or values for operating the processing device 2. In particular, by means of the keypad 16 a user can specify a desired length of the workpiece to be cut to length by the separating tool 4. For instance, the user enters the desired length 1 by means of the keypad 16 and subsequently presses a key for sending or starting, as a result of which the desired length is sent to the processing device 2 by the communication module 15. The communication module 13 receives the desired length, and a control unit of the processing device 2 controls the actuator 11 as a function of the received desired length in such a manner that the desired length is adjusted between the longitudinal stop 2 and the separating tool 4 by retracting or extending the telescopic arm 10, as indicated by a double-headed arrow. Accordingly, an automatic adjusting or shifting of the longitudinal stop 12 occurs which guarantees the separating or cutting of a workpiece to a desired length in straightforward manner. As an alternative to the exemplary embodiment described, the invention may also provide that the input device 14 has been integrated into the processing device 2, for example has been formed/arranged on the housing 6.

According to the present exemplary embodiment, the invention provides that the input device 14 is constituted by the distance gauge 3. In addition to the input device 14, the distance gauge 3 has a measuring device for contactless recording of at least one distance. In a particularly preferred manner, the invention provides that the measuring device takes the form of a laser measuring device 17.

As shown at the top in FIG. 1, the distance gauge 3 can, for instance, be placed with its rear side 18 against a wall 19 of a room, the laser measuring device 17 being arranged on the front side 20 of the distance gauge 3 facing away from the rear side 18. Given knowledge of the length of the distance gauge 3 itself, by virtue of the distance measurement by means of the laser measuring device 17 the overall length A of the room—or, to be more exact, of the spacing of wall 19 from the opposite wall—can then be ascertained in contactless manner. By means of the keypad 16 the user can then, for instance, give the command that the recorded length be transferred to the processing device 2, so that the longitudinal stop 12 is automatically adjusted—or, to be more exact, traversed—to the desired length. In this exemplary embodiment the desired length corresponds to length A.

By means of the keypad 16, however, the user also has the possibility to specify a set deviation from the desired length. This will be elucidated in more detail with reference to the exemplary embodiment shown in FIG. 2. In this exemplary embodiment the floor of the room is being laid with parquet flooring. The parquet pieces are provided in a prefabricated length and have to be at least partly adapted to the width of the room. In this connection it is important that a spacing between the last parquet piece from the respective wall of the room—the so-called gap dimension—remains, in order, for instance, to be able to reliably guarantee heat-induced expansions of the parquet and the provision of a baseboard in every case. If the user now places the distance gauge 3 against the piece of parquet or piece of laminate laid last, as indicated in FIG. 2, the distance still remaining from the opposite wall can be ascertained in contactless manner as described previously. If it is known to the user that a gap dimension is to remain, he/she can specify this by a corresponding input by means of the keypad 16 of the input device 14. According to a first exemplary embodiment, the invention provides that the user himself/herself enters the gap dimension exactly, for instance in millimeters or centimeters. According to a second exemplary embodiment, the invention may provide that the user presses a key by which a standard gap dimension is taken into account automatically by way of set deviation.

The desired length subsequently transferred to the processing device 2 then corresponds to the measured distance A minus the specified gap dimension S. The longitudinal stop 12 is adjusted appropriately to the desired length by triggering of the actuator 11, and the user can, by simple actuating of the processing device 2, cut the prefabricated parquet piece to the desired length.

According to the present exemplary embodiment, the invention provides that a distance gauge 3 or the input device 14 communicate directly with the processing device 2. Alternatively, it is also conceivable that, as shown in FIG. 1, a central unit 21, for instance in the form of a mobile telephone or mobile computer, is provided which itself has a communication module 23, by means of which the central unit 21 can communicate wirelessly both with the distance gauge 3 and with the processing means 2. In this case it is possible for the user to specify the desired gap dimension or the deviation from the recorded distance also by means of the central unit 21 which then transfers the final desired dimension—or, to be more exact, the desired length—to the processing device 2. For this purpose the central unit 21 exhibits the input device 14 or a further input device. Alternatively, the central unit 21 may also take the form of a fixed central server or host which transfers the data.

By virtue of the cutting-to-length system 1 it is now possible that the distance or desired length determined by the distance gauge 3 is transmitted to the processing device 2 directly or via the central unit 21. The distance gauge 3 preferentially has a memory in which several recorded lengths/distances can be stored which are then transmitted, in particular after a request by the user, simultaneously or almost simultaneously in one process or step to the central unit 21 or to the processing device 2.

The distance gauge 3 is preferably designed to record several distances simultaneously or in succession, in order to determine a cutting angle. If, for instance, the wall to which the workpiece to be cut to length is to lead extends at an angle a which deviates from an angle perpendicular to the longitudinal extent of the workpiece, as shown by dashed lines in FIG. 2, this angle can be ascertained by the recording of two distances which, situated side by side, are recorded in parallel, as indicated by dashed arrows in FIG. 2. In this case the angle a is imposed, in particular, as a function of a difference between the recorded distances. From this angle the cutting angle is determined automatically. The cutting angle is likewise transmitted by radio to the processing device, either directly or via the central unit 21, and the actuator 22 is triggered appropriately, in order to swivel the separating tool 4 in such a manner that the workpiece is cut to length at the desired angle. In a like manner the cutting to length, not represented, of trim moldings can also be undertaken. Since in the case of trim moldings the gap-free arrangement thereof above wall corners of the room is particularly desirable for aesthetic reasons but, measured conventionally, cutting them to length is extremely arduous and error-prone, particularly since trim moldings are typically oriented obliquely in relation to the wall and the ground, in this connection an automatic ascertainment of the cutting angle and, in particular, an automatic swiveling of the separating tool can enhance the ease of operation considerably.

1. A cutting-to-length system for cutting workpieces to a desired length, comprising:
a processing device including:
a separating tool, and
a longitudinal stop, the longitudinal stop displaceably mounted to adjust a desired length between the longitudinal stop and the separating tool;
a distance gauge configured to ascertain the desired length, wherein the processing device and the distance gauge respectively have a communication module for wireless or hard-wired transfer of data; and
an actuator assigned to the longitudinal stop and configured to displace the longitudinal stop, the actuator operable to adjust the desired length as a function of at least one distance recorded by the distance gauge.

2. The cutting-to-length system as claimed in claim 1, wherein the distance gauge is configured to record at least one distance in contactless manner.

3. The cutting-to-length system as claimed in claim 1, wherein the distance gauge is a laser gauge.

4. The cutting-to-length system as claimed in claim 1, further comprising:
a telescopic arm,
wherein the longitudinal stop is arranged at a free end of the telescopic arm and the free end of the telescopic arm is configured to extend and retract using the actuator.

5. The cutting-to-length system as claimed in claim 1, further comprising:
a central unit including a communication module configured to communicate with the processing device and with the distance gauge.

6. The cutting-to-length system as claimed in claim 1, wherein the distance gauge, the processing device or the central unit have an input device configured to enter at least one of (i) the desired length and (ii) a set deviation from a recorded distance.

7. The cutting-to-lenght system as claimed in claim 1, wherein the input device has a touch-sensitive screen or a keypad configured to specify at least one of (i) the desired length and (ii) the set deviation.

8. The cutting-to-length system as claimed in claim 1, wherein the input device has a communication module configured to receive the distance recorded by the distance gauge.

9. The cutting-to-length system as claimed in claim 1, wherein the separating tool is mounted such that the separating tool can swivel in order to adjust a cutting angle.

10. The cutting-to-length system as claimed in claim 1,
wherein the distance gauge is configured to record a cutting angle, and
wherein a further actuator is assigned to the separating tool, the further actuator configured to swivel the separating tool as a function of the recorded cutting angle.
